(19) United States
(12) Patent Application Publication
(10) Pub. No.: US 2023/0189310 A1
(43) Pub. Date: Jun. 15, 2023

(54) Load Balancing with a Multi-Radio Access Technology Access Point

(71) Applicant: Celona, Inc., Campbell, CA (US)

(72) Inventors: Srinivasan Balasubramanian, San Diego, CA (US); John Taylor, Campbell, CA (US)

(21) Appl. No.: 17/990,525

(22) Filed: Nov. 18, 2022

Related U.S. Application Data
(60) Provisional application No. 63/281,546, filed on Nov. 19, 2021.

(51) Int. Cl. H04W 72/52; H04W 28/08

(52) U.S. Cl. CPC H04W 72/52; H04W 28/0983; H04W 88/10

(57) ABSTRACT

Various embodiments of a method and apparatus for load balancing with a RAT (multi-Radio Access Technology) AP (Access Point) are disclosed. In some embodiments, dynamic bandwidth allocation for LTE (Long Term Evolution) and 5G NR (New Radio) is provided for a CBSDs (Citizen Broadband radio Service Devices) that support several types of RATs. In some embodiments, the UE population and the active traffic being exchanged in the full deployment and within each site is used to determine the required load balancing needs. In some embodiments, UEs (User Equipment) transition between LTE and 5G NR networks operating through the same CBSD. This is typically done for load balancing. In some embodiments, IP (Internet Protocol) and QoS (Quality of Service) transitions occur with transitions between the LTE and 5G NR networks and between eLTE (Evolved LTE) and NR. In some embodiments, seamless transitions are performed between LTE + WiFi and 5G NR + WiFi. In some embodiments, a unified core for EPC (Evolved Packet Core) and 5GC (5th Generation Packet Core) is provided.

### CLAIM OR PRIORITY TO PREVIOUSLY FILED PROVISIONAL APPLICATION -INCORPORATION BY REFERENCE

This utility application (ATTY. DOCKET NO. CEL-048-PAP) claims priority under 35 USC section 111 (b) and under 35 USC section 119 (e), to earlier-filed provisional application number 63/281,546 filed Nov. 19, 2021, entitled “Load Balancing with a Mutli-Rat AP” (ATTY. DOCKET NO. CEL-048-PROV); and the contents of the above-cited earlier-filed provisional application (App. No.: 63/281,546) is hereby incorporated by reference herein as if set forth in full.

### BACKGROUND

### Technical Field

The disclosed method and apparatus relate generally to systems for load balancing. In particular, the disclosed method and apparatus relate to load balancing with an mRAT (multi-Radio Access Technology) AP (Access Point).

### Background

The number of UEs (User Equipment) being produced that are only LTE (Long Term Evolution) capable and the number that are LTE + NR (New Radio) capable change constantly. Accordingly, the numbers of each such UE in service is constantly changing, even within a single day. In particular, the number of such devices that make up the UE population in service changes with each device upgrade cycle. In some cases, network architectures support LTE and NR protocols using the following three modalities: LTE-standalone mode, NR-standalone mode, and LTE + NR in a dual connectivity mode. LTE product limitations restrict the possible network architectures to supporting bandwidths of 20 MHz + 20 MHz peak bandwidth. NR allows for wider bandwidths (i.e., up to 100 MHz), but does not support CA (Carrier Aggregation). This may be an issue when the available spectrum is fragmented. This results in the number of UEs that are being supported by one particular RAT (Radio Access Technology) may substantially greater than the number of UEs being supported by other available RATs in a multi-RAT AP (Access Point) architecture.

Accordingly, it would be advantageous to provide a system that can balance loads with a multi-RAT AP.

### SUMMARY

Various embodiments of a method and apparatus for load balancing with an mRAT (multi-Radio Access Technology) AP (Access Point) are disclosed. In some embodiments, dynamic bandwidth allocation for LTE (Long Term Evolution networks) and NR (New Radio networks) is provided for CBSDs (Citizen Broadband radio Service Devices) that support several types of RATs. In some embodiments, UEs (User Equipment) transition between LTE and NR operating through the same CBSD to provide load balancing between such RATs. In some embodiments, IP (Internet Protocol) and QoS (Quality of Service) transitions occur with transitions between the LTE and NR networks and eLTE. An eLTE (Evolved LTE) eNB (Evolved Node-B) is an eNB that supports connectivity to an EPC (Evolved Packet Core), an NGC (Next Generation Core) and a 5GC (5^{th} Generation Packet Core). In some embodiments, seamless transitions are performed between LTE + WiFi and NR + WiFi. In some embodiments, a unified core for EPC and 5GC is provided.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader’s understanding of the disclosed method and apparatus. They should not be considered to limit the breadth, scope, or applicability of the claimed invention. It should be noted that for clarity and ease of illustration, these drawings are not necessarily made to scale.

FIG. 1 illustrates several variations of LTE (Long Term Evolution) and NR (New Radio) network architectures interconnecting with the EPC (Evolved Packet Core) and 5GC (5^{th} Generation Packet Core) packet core networks in which the current systems and methods are applied.

FIG. 2 illustrates UE (User Equipment) connectivity options in a tabular form, indicating the primary and secondary RATs (Radio Access Technology devices) along with the 3GPP (3^{rd} Generation Partnership Project) term used for the configuration in which current systems and methods are applied.

FIG. 3 illustrates a high-level architecture of both an LTE and an NR system in which the bandwidth for the RAT in each system is dynamically allocated into an enterprise network in conjunction with the allocation of the connectivity of a Wi-Fi RAT.

FIG. 4 illustrates an LTE eNB and a 5G NR gNB in communication with a SAS (Spectrum Access System) via a DP (Domain Proxy).

FIG. 5 illustrates a network architecture for tunnel integration into the EPC/5GC along with the Wi-Fi connectivity.

FIG. 6 illustrates routing over LTE/NR, Wi-Fi, using a single VPN (Virtual Private Network) tunnel.

FIG. 7 illustrates a Converged Core in which a 4G LTE EPC and a 5G NR 5GC operate together.

The figures are not intended to be exhaustive or to limit the claimed invention to the precise form disclosed. It should be understood that the disclosed method and apparatus can be practiced with modification and alteration and that the invention should be limited only by the claims and the equivalents thereof.

### DETAILED DESCRIPTION

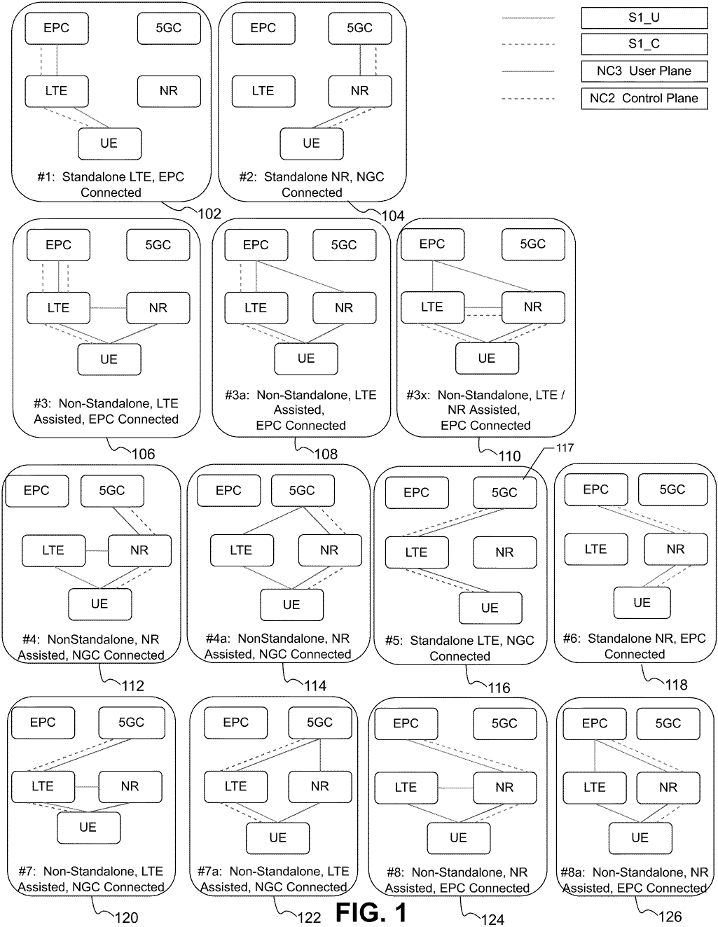

FIG. 1 illustrates several variations of LTE (Long Term Evolution) -NR (New Radio) network architectures interconnecting with the EPC (Evolved Packet Core) and 5GC (5th Generation Packet Core) packet core networks in which the presently disclosed systems and methods are applied. Two instances of a standalone LTE EPC 102, 104 are shown. In the first, the LTE standalone mode with EPC 102 is shown. In the second, the NR standalone with 5GC 104 is shown. In addition, four Non-Standalone modes are shown. Three versions of the first Non-Standalone mode with LTE assisted and NR operations with EPC 106, 108, 110 are shown. Three versions of the second is a Non-Standalone mode with NR assisted and LTE operations with 5GC 112, 114, 116 are shown. Two versions of the third is a Non-Standalone mode with LTE assisted and NR operations with 5GC 120, 122 are shown. Two versions of the fourth is a Non-Standalone mode with NR assisted and LTE operations with EPC 124, 126 are shown.

### IP and QoS Context

In some embodiments of the disclosed architectures the context is reestablished with EPC 127 and 5GC 129 transitions. Applications will see an interruption in response to such transitions. Enabling support for PS-fallback (packet switched fallback) from NR to LTE allows the authorization context to be transferred with minimal breaks in continuity. In some embodiments of the disclosed method and apparatus, this is implemented by transitioning 5GC-5QIs (5GC Quality of service Identifiers) to EPC 127 EPC-QCIs (Quality of service Class Identifiers). Also, in some embodiments, network slices are transitioned to a common core network with the EPC for the network slices that can be transitioned. Given that the network slices will be realized as an independent VLAN (Virtual Local Area Networks), the network slices should be transferable to the EPC domain as independent PDN (Packet Data Network) connections. With eLTE and use of the network architecture 116, the 5GC 129 can be used for both LTE and NR and can support seamless transitions without breaks in IP and QoS connectivity. This includes the slice functionality, which is also not interrupted.

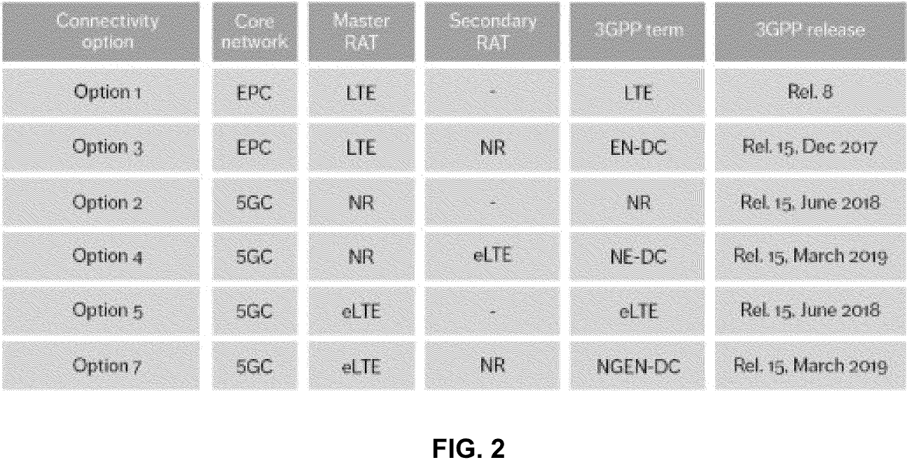

FIG. 2 illustrates the UE connectivity options shown in FIG. 1 in a tabular form, as well as indicating the primary and secondary RATs along with the 3GPP term used for the configuration in which the current systems and methods are applied.

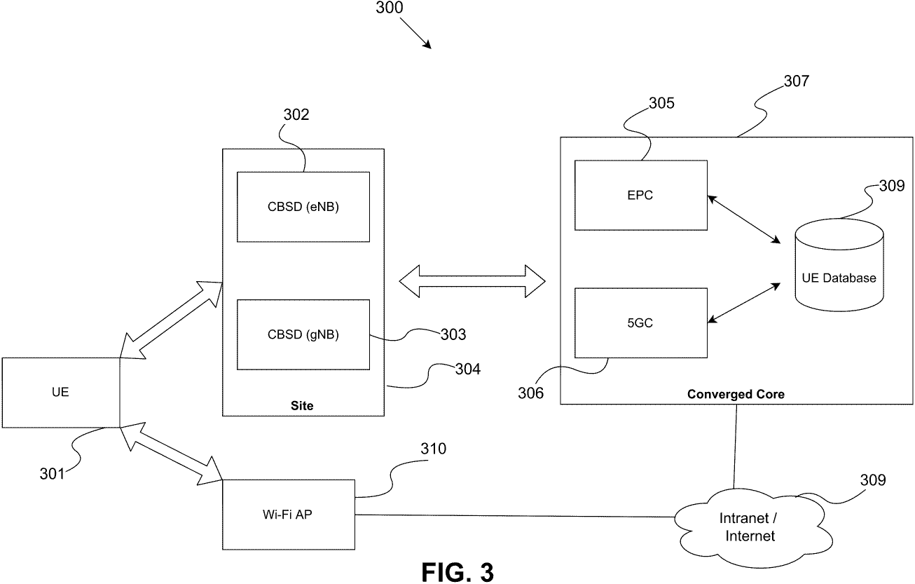

FIG. 3 illustrates a high-level architecture of LTE and NR system 300. An LTE CBSD eNB 302 and NR CBSD gNB 303 are deployed in a Site 304 in which the bandwidth of each RAT is allocated dynamically along with the connectivity of Wi-Fi AP 310 into the enterprise network. The LTE CBSD eNB 302 and NR CBSD gNB 303 connect to the Converged Core 307. UE 301 connects to the networks via the LTE, NR and Wi-Fi RAT. A given enterprise deployment supports one or more Sites 304. The loading is determined based on enterprise-site-wide capabilities at the Converged Core 307 and on the UE population associated with each Site 304 retained in the UE database 309.

### Dynamic Allocation of Bandwidth to LTE and NR

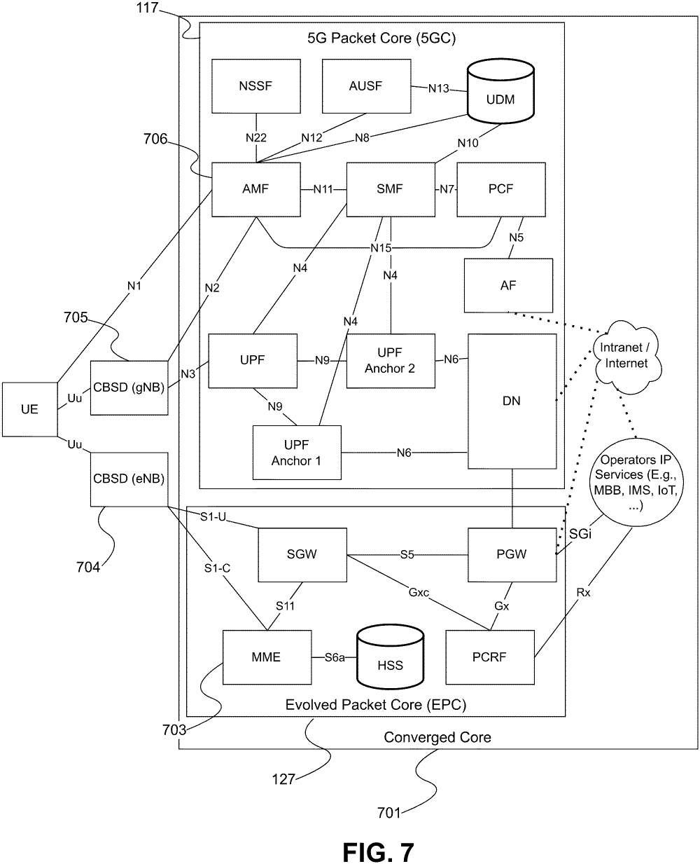

The high-level architecture of LTE and NR system 300 has bandwidth for each RAT that is allocated dynamically along with the connectivity of Wi-Fi RAT into the enterprise network. FIG. 7 illustrates the 4G LTE and 5G NR networks together with the EPC 127 and 5GC 129 together forming the Converged Core 701. In some embodiments, with a unified core for EPC 127 and 5GC 129, transitions of the UE across LTE-only and NR-SA-mode are handled seamlessly to provide better service. In some embodiments, the subscription information is retained in a central location of UE Database 309 carrying the credential information for the UE to access the network via LTE and NR. In some embodiments, this UE information is enhanced to support the information discussed below to enable quicker/more seamless mobility across LTE and NR.

### Dynamic Switching Between LTE + WiFi and NR + WiFi Operation

In the high-level architecture of LTE and NR system 300, when transitioning across LTE and NR, it is possible to use the MAPCON (Multi-Access PDN Connectivity) feature and transition all IP contexts to the WiFi AP 310 domain. Once the target RAT (e.g., an LTE RAT or an NR RAT) is established, the IP context can be moved to the target RAT while retaining the required flows on WiFi. Such transitions can be considered (e.g., performed) along with features of LWA (LTE/WiFi aggregation), VPN style connectivity with a single IP address anchor with the outer-IP address assigned as part of LTE/NR and WiFi, which is discussed further below, and Multi-path TCP (Transition Control Protocol), which may also be transitioned or performed.

### Dynamic Allocation of Bandwidth to LTE and NR

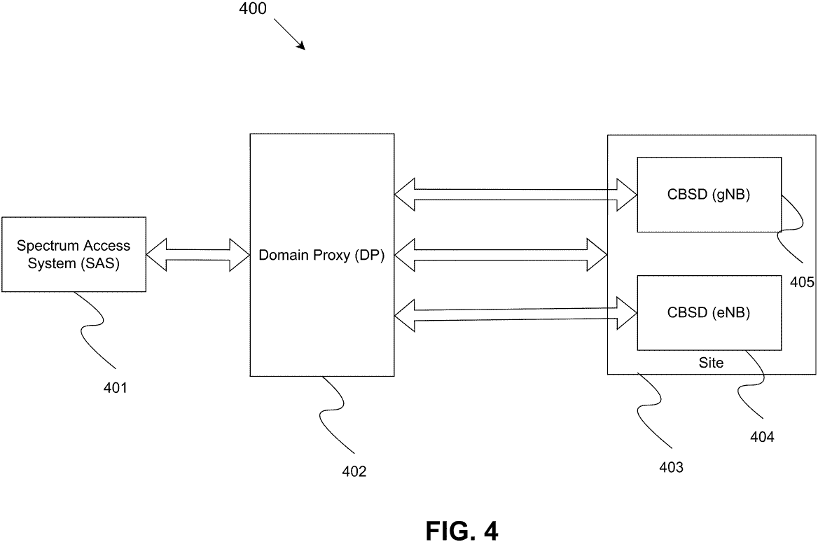

FIG. 4 illustrates a site deployment 400 supporting both LTE eNB and 5G NR gNB along with the communication to the SAS (Spectrum Access System) via the DP (Domain Proxy). In some embodiments, the CBSDs (Citizen Broadband Radio Service Devices) supports both LTE and NR with close proximity to each other in Site 403. The CBSD 404 and 405 registers with the SAS 401 as a single entity for channel allocation via the DP 402. A SON (Self-Organizing Network) algorithm, when partitioning the channels across the CBSD, performs a combined allocation for both LTE CBSD (e.g., an eNB) 404 and 5G NR CBSD (e.g., a gNB) 405. The decision of how to partition the bandwidth allocation across LTE CBSD 404 and NR CBSD 405 for that Site 403 is decided based on the predicted traffic demand, taking into account the UE population and the associated LTE and NR capabilities of those UEs.

In some embodiments of the site deployment 400, the LTE CBSD 404 and NR CBSD 405 are deployed in a Site 403, and need to independently request the SAS for channel allocation. The request for additional bandwidth allocation for either LTE CBSD 404 or NR CBSD 405 is sent together with the request to relinquish the use of the corresponding bandwidth from the other CBSD from the Site 403 so that the SAS can process them together.

### Bandwidth Allocation Algorithm

In some embodiments, there is a greater tendency to increase LTE allocation given that an NR-capable UE will also support LTE, and the NR-capable UE can be transitioned to LTE for operation.

### Load Balancing Across LTE and NR RATs

In some embodiments of the site deployment 400, once the channel allocation for LTE CBSD 404 and 5G NR CBSD 405 is determined for a Site 403, the allocation tends to remain relatively static. In some embodiments, the bandwidth allocation may potentially change only a few times during any given day. It is possible that the bandwidth allocated to 5G NR CBSD flows may not be able to manage the capacity of the NR UEs currently in the network. There are at least two approaches to address this issue. In a first approach, bandwidth is assigned dynamically to LTE CBSD 404 and 5G NR CBSD 405 based on the capabilities of the UEs accessing the network. Bandwidth reallocation typically can be done only during idle time at the CBSD. Reallocation during idle time requires the UE to be offloaded to the neighboring cell to allow the reallocation to occur. The first approach is typically harder to achieve than the second approach.

In the second approach, the UE is dynamically transitioned across the LTE and NR RAT for load balancing. A finite subset of the NR UEs is handed over from NR to LTE. It is performed as an IRAT HO (Inter Radio Access Technology Handover) using the PS-fallback (packet switched fallback) procedures for transitioning from NR to LTE.

In some embodiments, the second approach is preferred until the bandwidth can be rebalanced across LTE and NR.

### UE Capability

In some embodiments, the UE capability is requested from the UE either on LTE or NR, based on where the UE accesses the network. The UE capabilities are reused across both LTE and NR without re-requesting for it. In some embodiments, the UE capability request is made broader (e.g., by requesting that the information be provided, to or made available to, multiple types of devices) to allow the UE to report all its capability for both LTE and NR, independent of the radio where it initially associates itself.

In some embodiments, the UE information is enhanced to support the below information to enable quicker/more seamless mobility across LTE and NR portions of the network.

### Dynamic Switching Between LTE + WiFi and NR + WiFi Operation

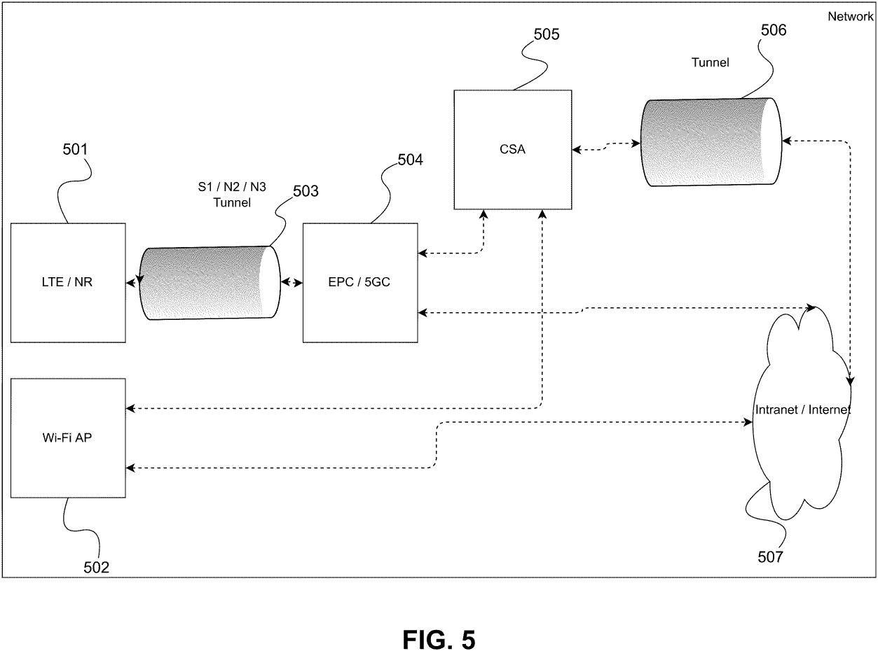

FIG. 5 illustrates a network architecture for tunnel integration into the EPC / 5GC along with the Wi-Fi connectivity.

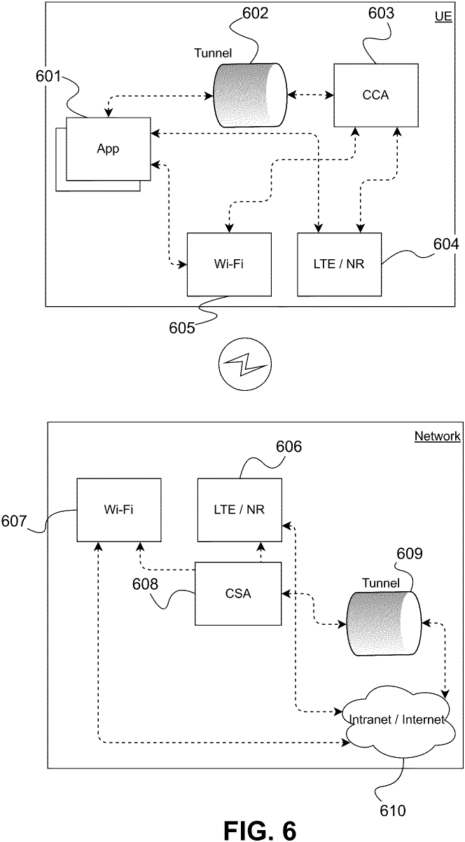

FIG. 6 illustrates routing over LTE/NR, WiFi, and a single VPN tunnel. In FIGS. 4 and 5, a CSA (Cloud Services Appliance) 608 is integrated onto the PSE (Packet Switched Equipment) as an overlay network behind the EPC / 5GC 504 and the WiFi AP 502. The CCA (Cloud Computing Appliance) 603 and CSA (Cloud Services Appliance) 608 act like a proprietary tunnel “overlay network”. In some embodiments, an additional virtual interface IP for CSA (sometimes referred to as a “CSA service IP”) is on the PSE. UDP (User Datagram Protocol) sockets are created to connect between the CCA 603 and CSA 608. The CSA 608 behaves as a tunnel gateway and can be hosted on the PSE or as a separate independent node. The GTP-U (GPRS-general packet radio service - tunneling protocol underlay) S1 tunnel is part of this underlay network. The GTP-U is used for carrying user data within the GPRS core network and between the radio access network and the core network.

### Seamless Mobility Across LTE and NR With Common Data Store for UE Capabilities/Policies/Credentials

FIG. 7 illustrates the 4G LTE and 5G NR networks together with the EPC 127 and 5GC 129 together forming the Converged Core 701. Handling of authorization context for a UE (i.e., the information required to allow the network to authorize a UE to gain access to the network) at the MME (Mobility Management Entity) 703 in LTE networks and at the AMF (Access and Mobility Management Function) 706 in NR may be done in at least two ways. In a first approach, the MME 703 and AMF 706 authorization contexts are stored interdependently. This establishes them for the first time when the UE accesses the network. The context is reused for subsequent transitions.

In a second approach, the LTE node is supported as eLTE, where the LTE node is connected to the SGC 129. In some embodiments, only the AMF 706 is used in the Converged Core 701, and that authorization context is used across both LTE and NR

Although the disclosed method and apparatus is described above in terms of various examples of embodiments and implementations, it should be understood that the particular features, aspects, and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a) a processor;
b) a converged core supporting combined EPC (evolved packet core) and 5GC (5^{th} generation packet core) with multiple RATs (radio access technologies) in a deployment; and
c) a memory system having a non-transitory storage medium, storing one or more machine instructions, which when implemented, cause the processor to dynamically allocate bandwidth between multiple radio access technologies.

2. The system of claim 1, wherein the deployment supports multiple sites and each site supporting LTE (Long Term Evolution) and 5G NR (5^{th} Generation New Radio) base stations.

3. The system of claim 1, wherein:
the converged core queries the UEs (User Equipment) and acquire their individual UE capabilities for LTE and NR RAT support;
the converged core determines the current population of the UEs in the deployment and also with each site;.

4. The system of claim 3, wherein:
the converged core determines a bandwidth allocation to each site within the deployment;
dividing the bandwidth allocation to a CBSD (Citizens Broadband Radio Service Device);.

5. The system of claim 4, wherein the CBSD is an eNB (eNodeB).

6. The system of claim 4, wherein the CBSD is a gNB (gNodeB).

7. The system of claim 4, wherein:
the LTE CBSD (eNB) and 5G NR CBSD (gNB) request a SAS to provide the required spectrum allocations based on the determined bandwidth requirements.
the request is sent to the SAS (Spectrum Access System) accumulating the requests from all the sites and RATs of the full deployment;.

8. The system of claim 7, wherein:
the request to the SAS placed as a combined requests for the LTE CBSD (eNB) and 5G NR CBSD (gNB) or
sending individual request with CBSD initiating a request for additional bandwidth with the other CBSD releasing the corresponding bandwidth to accommodate the bandwidth expansion request of the initiating CBSD;.

9. The system of claim 8, wherein:
the SAS provides the allocations to the CBSDs and a SON algorithm is run to further balancing the bandwidth across the sites based on the determined UE demands.

10. The method of claim 9, wherein:
the UEs are actively moved to an alternative RAT to offload capacity prior to initiating the bandwidth allocation changes.

11. The method of claim 10, wherein:
the UE flows are transitioned to Wi-Fi AP to free up resources temporarily in the CBSD prior to initiating the bandwidth allocation changes.

12. The system of claim 3, wherein:
UE capability information is retained in a common location across 5G NR, LTE, and Wi-Fi RAT networks.

13. The system of claim 12, wherein:
the UE capability information is used to select the UEs to be transitioned to one of a 5G NR RAT, LTE RAT, or Wi-Fi RAT, based on a determined load balancing requirement within a given site and across sites for the deployment.

14. The system of claim 13, wherein:
inter-RAT packet-switched transitions are employed to ensure continuity of operation for UE QoS flows.

15. The system of claim 14, wherein:
transitioning QoS criteria across 5GC-5QIs and EPC-QCI parameterization to maintain consistency of operations across RAT transitions.

16. The system of claim 15, wherein:
A VPN tunnel is established that allow for single IP context to be used across the RATs to prevent break due to IP address changes during inter-RAT transitions.

17. The method of claim 10, wherein:
transitions across RATs are managed by anchoring the UE in SGC with both LTE and 5G NR connectivity for the UE is anchored in a single packet core network.
